(19) United States
(12) Patent Application Publication
(10) Pub. No.: US 2018/0060921 A1
(43) Pub. Date: Mar. 1, 2018

(54) AUGMENTING VISIBLE CONTENT OF AD CREATIVES BASED ON DOCUMENTS ASSOCIATED WITH LINKED TO DESTINATIONS

(71) Applicant: Google Inc., Mountain View, CA (US)

(72) Inventors: Advay Mengle, Sunnyvale, CA (US); Ertan Dogrultan, San Francisco, CA (US); James Christopher Davidson, Oakland, CA (US)

(21) Appl. No.: 14/644,643

(22) Filed: Mar. 11, 2015

(51) Int. Cl. G06Q 30/02

(52) U.S. Cl. CPC G06Q 30/0276

(57) ABSTRACT

Methods, apparatus, systems, and computer-readable media are provided for augmenting visible content of ad creatives. In various implementations, a document associated with a destination linked to by an ad creative may be identified. One or more templates may be applied to content of the document to identify at least one content candidate with which to augment visible content of the ad creative. It may be determined that the at least one content candidate satisfies a criterion. Visible content of the ad creative may be augmented based on the at least one content candidate.

### BACKGROUND

An “ad creative” may refer to content, often generated by an advertiser, which may be presented in a computer application (often but not necessarily a web browser) as a link to a destination associated with a particular entity being advertised. The content of an ad creative may be selected to maximize consumer response, and often includes things like the name of the entity being advertised, a slogan, a short phrase describing the good or service being marketed, and so forth.

In the search engine context, when a user submits a search query, two types of search results may be returned in response. “Web search” results may include hyperlinks to various web documents (e.g., web pages) that are responsive to the query. Web search results are typically selected from a corpus of documents that are pre-crawled and/or indexed in a more or less neutral manner (e.g., based purely on their content). “Sponsored” search results may include one or more ad creatives that are responsive to the query and that link to advertiser-generated documents (e.g., advertiser webpages). Sponsored search results typically are selected from a corpus of advertisements (ad creatives and other similar content). Sponsored search results often (but not necessarily) are presented above and/or to the side of web search results, and when clicked may cause revenue to be provided to a search engine entity.

### SUMMARY

The present disclosure is generally directed to methods, apparatus, and computer-readable media (transitory and non-transitory) for augmenting visible content of ad creatives based on content of documents associated with destinations linked to by the ad creatives. An ad creative may include visible content (i.e., content that will be presented visually to the user, as opposed to content that the user cannot see on his or her screen) such as an entity name, an entity slogan, one or more catchphrases, etc., as well as invisible content such as one or more bid phrases, URLs underlying hyperlinks, and so forth. An ad creative that links to a landing page with content that is closely aligned with content of the ad creative may be more effective (e.g., it may achieve a higher click-through-rate, or “CTR”) than an ad creative and landing page pair that are less-closely aligned. Therefore, techniques are described herein for applying one or more so-called “templates” to one or more documents associated with a destination linked to by an ad creative (e.g., the landing page and other related pages in a domain) to identify so-called “content candidates.” A “content candidate” may be a string of text, an n-gram, a series of tokens, etc., that may be considered for addition to visible content of the ad creative (i.e. to “augment” visible content of ad creative). Content candidates may be extracted directly from landing page text (or other pages in a domain), or may be identified, e.g., as derived based on content of a landing page (or other pages in a domain). In some implementations, one or more content candidates may be rewritten using various rewriting rules to derive multiple variants, each which may be considered separately as a content candidate. Once multiple content candidates are identified, they may be pruned and/or scored using various techniques and/or criteria, until one or more content candidates is left to be used to augment visible content of the ad creative.

In some implementations, a computer implemented method may be provided that includes the steps of: identifying a document associated with a destination linked to by an ad creative; applying one or more templates to content of the document to identify at least one content candidate with which to augment visible content of the ad creative; determining that the at least one content candidate satisfies a criterion; and augmenting visible content of the ad creative based on the at least one content candidate.

This method and other implementations of technology disclosed herein may each optionally include one or more of the following features.

In various implementations, applying the one or more templates to content of the document may include applying the one or more templates to content of the document to identify a plurality of content candidates. In various implementations, the determining may include calculating scores for the plurality of content candidates, and selecting, from the plurality of content candidates, a content candidate for the augmenting based on the scores. In various implementations, calculating a score for a given content candidate may include calculating the score based on a comparison of a first context in which the given content candidate is associated with the document and a second context associated with the ad creative.

In various implementations, the method may further include eliminating one or more content candidates from the plurality of content candidates based on one or more measures of redundancy detected between the one or more content candidates. In various implementations, the method may further include eliminating at least one content candidate from the plurality of content candidates based on a measure of redundancy detected between the at least one content candidate and the visible content of the ad creative. In various implementations, the method may further include ranking the plurality of content candidates based on semantic similarity with visible content of the ad creative. In various implementations, the method may further include ranking the plurality of content candidates based on templates used to identify them. In various implementations, the method may further include ranking the plurality of content candidates based on a category assigned to the ad creative.

In various implementations, the criterion may include a first context associated with the document being compatible with a second context associated with the ad creative. In various implementations, the method may include building a parse tree based on the content of the document, and ranking a plurality of content candidates based on one or more aspects of the parse tree. In various implementations, the one or more aspects of the parse tree may include absence or presence of negation language, one or more path distances, one or more restrictive clauses, and/or one or more dependency paths.

In various implementations, the method may further include inspecting a portion of the document within a predetermined character or structured path distance of content that led to identification of the at least one content candidate for negating language. In various implementations, determining that the at least one content candidate satisfies the criterion includes determining that an age of the at least one content candidate satisfies an age criterion. In various implementations, wherein the age criterion comprises a maximum age. In various implementations, the age criterion comprises a maximum age relative to an age of the ad creative.

In various implementations, the method may further include identifying one or more rewrite rules for the at least one content candidate, and generating one or more rewrites of the content candidate based on the one or more rewrite rules. In various implementations, the method may further include selecting, from the content candidate and the one or more rewrites, content with which to augment the visible content of the ad creative.

In various implementations, the method may further include selecting the one or more templates from a plurality of templates based on one or more signals associated with the ad creative. In various implementations, the method may further include selecting the one or more templates from a plurality of templates based on one or more signals associated with the document or the destination.

In another aspect, a computer implemented method may be provided that includes the steps of: identifying, by a computing system, a relationship between first content of a first ad creative and second content of a first document associated with a first destination linked to by the first ad creative; and generating, by the computing system, a template configured to identify, based on the relationship and a second document associated with a second destination linked to by a second ad creative, candidate content with which to augment visible content of the second ad creative.

This method and other implementations of technology disclosed herein may each optionally include one or more of the following features.

In various implementations, the method may further include determining, by the computing system, a pattern that matches both the first and second contents, and incorporating, by the computing system, the pattern into the template, wherein the template is further configured to match the pattern to third content of the second document. In various implementations, the template is further configured to identify the candidate content based on the third content. In various implementations, the relationship comprises both the first and second content matching the pattern.

In various implementations, the method may further include identifying, by the computing system, occurrence of the relationship between third content of a third ad creative and fourth content of a third document associated with a third destination linked to by the third ad creative. In various implementations, the method may further include determining, by the computing system, a pattern that matches the first, second, third, and fourth contents, and incorporating, by the computing system, the pattern into the template, wherein the template is further configured to match the pattern to content of the second document. In various implementations, the method may further include altering a score associated with the template based on identification of the relationship between the first and second contents, and between the third and fourth contents, to increase a likelihood that the template will be selected from a plurality of templates.

In various implementations, the method may further include assigning a score to the template. In various implementations, the method may further include assigning the score to the template based on a term frequency-inverse document frequency of the second content. In various implementations, the relationship may include a syntactic relationship between the first content and the second content. In various implementations, the relationship may include a semantic relationship between one or more entities identified in the first content or the second content. In various implementations, the first content and the second content are identical.

Other implementations may include a non-transitory computer readable storage medium storing instructions executable by a processor to perform a method such as one or more of the methods described above. Yet another implementation may include a system including memory and one or more processors operable to execute instructions, stored in the memory, to implement one or more modules or engines that, alone or collectively, perform a method such as one or more of the methods described above.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 schematically illustrates an example environment in which content candidates may be identified for potential augmentation of visible content of ad creatives, in accordance with various implementations.

FIG. 2 schematically depicts an example of how ad creatives and documents associated with destinations linked to by the ad creatives (e.g., landing pages and other pages in the same domain) may be analyzed by various components described herein to selectively augment visible content of the ad creatives, in accordance with various implementations.

FIG. 3 schematically depicts an example of how visible content of an ad creative may be augmented based on content of a landing page linked-to by the ad creative and other documents in the same domain, in accordance with various implementations.

FIG. 4 schematically depicts a flow chart illustrating an example method of selectively augmenting visible content of ad creatives based on content of documents associated with destinations linked to by the ad creatives, in accordance with various implementations.

FIG. 5 schematically depicts another flow chart illustrating an example method of generating templates for identifying content candidates for augmentation of visible content of ad creatives, in accordance with various implementations.

FIG. 6 schematically depicts an example architecture of a computer system.

### DETAILED DESCRIPTION

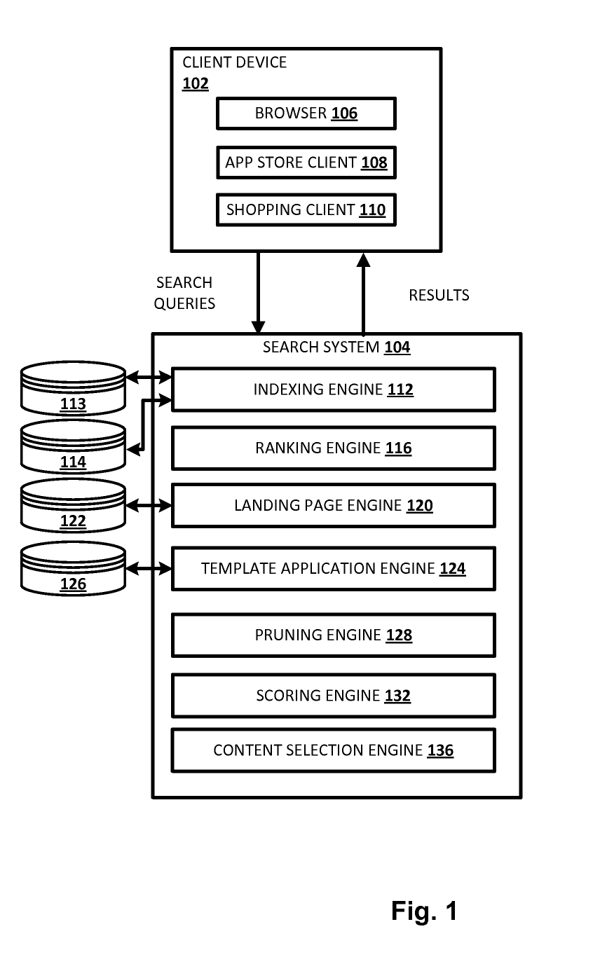

FIG. 1 illustrates an example environment in which content candidates may be identified for potential augmentation of visible content of ad creatives. The example environment includes a client device 102 and a search system 104. Search system 104 may be implemented in one or more computers that communicate, for example, through a network (not depicted). Search system 104 is an example of an information retrieval system in which the systems, components, and techniques described herein may be implemented and/or with which systems, components, and techniques described herein may interface.

A user may interact with search system 104 via client device 102. Search system 104 receives search queries from the client device 102 and returns search results in response to the search queries. Each search query is a request for information. A search query may be, for example, in a text form and/or in other forms such as, for example, audio form and/or image form. Other computer devices may submit search queries to search system 104 such as additional client devices and/or one or more servers implementing a service for a website that has partnered with the provider of search system 104. For brevity, however, the examples are described in the context of client device 102.

Client device 102 may be a computer coupled to search system 104 through a network (not depicted) such as a local area network (LAN) or wide area network (WAN) such as the Internet. Client device 102 may be, for example, a desktop computing device, a laptop computing device, a tablet computing device, a mobile phone computing device, a computing device of a vehicle of the user (e.g., an in-vehicle communications system, an in-vehicle entertainment system, an in-vehicle navigation system), or a wearable apparatus of the user that includes a computing device (e.g., a watch of the user having a computing device, glasses of the user having a computing device). Additional and/or alternative client devices may be provided. Client device 102 typically includes one or more applications to facilitate submission of search queries and the sending and receiving of data over a network. For example, client device 102 may execute one or more applications, such as a browser 106, application store client 108, and/or shopping client 110, that allow users to formulate queries and submit the queries to the search system 104.

In some implementations, client device 102 may execute one or more applications, such as browser 106, application store client 108, and/or shopping client 110, that execute instructions provided by the search system 104 to modify search results based on one or more signals. Client device 102 and search system 104 each include memory for storage of data and software applications, a processor for accessing data and executing applications, and components that facilitate communication over a network. The operations performed by client device 102 and/or search system 104 may be distributed across multiple computer systems. Search system 104 may be implemented as, for example, computer programs running on one or more computers in one or more locations that are coupled to each other through a network.

Search system 104 may include an indexing engine 112, a ranking engine 116, a landing page engine 120, a template application engine 124, a pruning engine 128, a scoring engine 132, and/or a content selection engine 136. In some implementations one or more of engines 112, 116, 120, 124, 128, 132, and/or 136 may be omitted. In some implementations all or aspects of one or more of engines 112, 116, 120, 124, 128, 132, and/or 136 may be combined. In some implementations, one or more of engines 112, 116, 120, 124, 128, 132, and/or 136 may be implemented in a component that is separate from the search system 104. In some implementations, one or more of engines 112, 116, 120, 124, 128, 132, and/or 136, or any operative portion thereof, may be implemented in a component that is executed by client device 102.

Indexing engine 112 may maintain indices 113 and 114 for use by search system 104. Indexing engine 112 may processes documents and update index entries in indices 113 and 114, for example, using conventional and/or other indexing techniques. For example, indexing engine 112 may crawl one or more resources such as the World Wide Web and index documents accessed via such crawling in index 113. As another example, indexing engine 112 may receive information related to ad creatives (e.g., keywords) from resources such as advertisers and index ad creatives in index 114 based on such information. Put another way, index 113 may be used to store data pertaining to documents and other materials that may be returned as “web search” results. Index 114, by contrast, may be used to store data pertaining to advertising, such as banner ads, ad creatives, etc., that may be returned as “sponsored” search results. A document is any data that is associated with a document address. Documents include web pages, word processing documents, portable document format (PDF) documents, images, emails, calendar entries, videos, and web feeds, to name just a few. Each document may include content such as, for example: text, images, videos, sounds, embedded information (e.g., meta information and/or hyperlinks); and/or embedded instructions (e.g., ECMAScript implementations such as JavaScript).

Ranking engine 116 may use indices 113, 114, and/or other sources of data to identify documents and other information responsive to a search query, for example, using conventional and/or other information retrieval techniques. Ranking engine 116 may calculate scores for the documents and other information identified as responsive to the search query, for example, using one or more ranking signals. Each ranking signal may provide information about the document or information itself, the relationship between the document or information and the search query, and/or the relationship between the document or information and the user performing the search. In various implementations, ranking engine 116 ultimately may return, e.g., to client device 102, search results that are responsive to the search query. As noted in the background, some of these search results may be so-called “web search” results, and may identify documents and other items determined to be responsive based primarily or exclusively on their content (e.g., selected from index 113). Other search results may be “sponsored,” and may be obtained for instance from index 114.

In this specification, the term “database” and “index” will be used broadly to refer to any collection of data. The data of the database and/or the index does not need to be structured in any particular way and it can be stored on storage devices in one or more geographic locations. Thus, for example, the indices 113 and 114 may include multiple collections of data, each of which may be organized and accessed differently.

Landing page engine 120 may be configured to, on receipt of a destination identifier such as a URL, retrieve one or more documents (or portions thereof) associated with the destination. For example, landing page engine 120 may identify a URL linked to by an ad creative that is, for instance, selected by ranking engine 116 as responsive to a search query. Landing page engine 120 may then retrieve one or more documents (or preprocessed portions thereof) associated with a destination linked to by the ad creative, e.g., from the original source or from a cached page index 122. In some instances, landing page engine 120 may retrieve the landing page to which the ad creative links. In some instances, landing page engine 120 may additionally or alternatively retrieve other documents associated with the landing page, such as other web pages in the same domain.

In some implementations, landing page engine 120 or another component may prune documents it retrieves to remove content that is unlikely to contain, or result in identification of, content candidates that likely would be suitable for augmenting an ad creative. For example, in some implementations, landing page engine 120 may identify portions of documents such as user comments, unrelated ad creatives, boilerplate in some circumstances, and other portions unlikely to contain content suitable for augmenting a particular ad creative, and may prune, annotate or otherwise indicate that these portions should not be considered by downstream components. Whole documents may be discarded and/or disregarded if, for instance, they are unavailable (e.g., HTTP 404 error), empty, incorrectly crawled (e.g., by indexing engine 112), and/or entirely out of context with an ad creative under consideration. In some implementations, landing page engine 120 may store only the content of documents that remain after pruning in index 122. In some implementations, when an ad creative links to a product search page, landing page engine 120 may narrow content from the product search to content pertaining to a particular product represented by the ad creative. In other implementations, landing page engine 120 may simply disregard and/or discard product search pages because there is too high of a risk they will contain out-of-context information.

In some implementations, landing page engine 120 and/or one or more other components may apply various natural language processing techniques to add annotations to documents for use by downstream components in identifying content candidates. For example, various grammatical information may be annotated, including but not limited to nouns, pronouns, parts of speech, verbs, adverbs, adjectives, tense, subject class, and so forth. In some implementations, content between certain delimiters (e.g., HTML heading or title tags), or content that is successfully parsed in to a parse tree, may be annotated. In some implementations, byte intervals may be annotated, e.g., to identify portions of a document likely or unlikely to contain suitable content candidates, such as a “centerpiece” portion, user comments, products related to the product represented by an ad creative, etc. In some implementations, metadata associated with a document, such as its last modified date, creation date, etc., may be annotated.

Once one or more documents associated with the destination linked to by an ad creative are retrieved (and in some cases, pruned and/or annotated), template application engine 124 may be configured to select one or more templates (sometimes referred to as “linguistic templates”) from index 126 for application to content of the retrieved documents to identify one or more content candidates for use in augmenting visible content of the ad creative. Examples of templates will be discussed below, and may include but are not limited to regular expression-based templates, instance-based templates, parsing templates, and so forth.

In many instances, multiple content candidates may be identified and/or extracted by template application engine 124. However, there may be practical limits as to how many content candidates can or should be added to visible content of ad creatives before they become unwieldy and/or inundate users with too much information. Accordingly, it may be necessary to narrow those candidates to a number that can effectively and/or feasibly be added to visible content of an ad creative. Accordingly, pruning engine 128 and/or scoring engine 132 may utilize various techniques to reduce multiple content candidates to a reasonable number of the most suitable content candidates for addition to visible content of ad creatives.

For example, pruning engine 128 may be configured to utilize various techniques for determining redundancy and/or contextual compatibility to eliminate (or “prune”) one or more content candidates from consideration. Additionally or alternatively, scoring engine 132 may be configured to score remaining content candidates based on a variety of signals that will be described below. Based on those scores, content selection engine 136 may be configured to augment visible content the ad creative with one or more content candidates.

As a simple example, suppose a user operates client device 102 to provide the search query “high quality American auto parts.” Ranking engine 116 may identify one or more responsive web search results from index 113 and one or more responsive sponsored search results from index 114. Suppose the sponsored search results include an ad creative for Bob's Auto Parts with visible content that includes the name of the entity (“Bob's Auto Parts”), contact information, and perhaps a slogan (e.g., “Bob knows auto parts”). Suppose this ad creative links to a home page for Bob's Auto Parts, and displayed prominently on that homepage and on web pages under the same domain is the text “ALL PARTS PROUDLY MADE IN THE USA.” Based on prior analysis of a corpus of ad creatives and corresponding linked-to documents, one or more templates may be designed to identify instances of “MADE IN THE USA” in landing page documents as content candidates. This content candidate may be scored relatively highly, e.g., by scoring engine 132. For instance, it may have been observed during template generation or from subsequent user activity (e.g., CTR) that ad creatives that state “MADE IN THE USA” or some variant thereof are more likely to earn a user's click than ad creatives without such text. Based on this score, content selection engine 136 may select this content candidate for use in augmenting visible content of the ad creative, e.g., by appending the text “MADE IN THE USA” to a portion of the visible content.

The scenario described above—in which an ad creative is selected and documents associated with its linked to destination are analyzed in real time in response to a user search query and then augmented with one or more content candidates—is just one possible scenario in which disclosed techniques may be applied. In other implementations, a corpus of ad creatives and documents associated with their linked to destinations may be analyzed, and possibly augmented in bulk. In yet other implementations a corpus of documents such as landing pages may be analyzed independently of ad creatives to identify various content candidates that may be thereafter associated with those documents. When an ad creative comes along (e.g., in response to a search query) that links to these documents, already-identified content candidates associated with those documents may be analyzed, e.g., to determine contextual compatibility, and then used to selectively augment the ad creative.

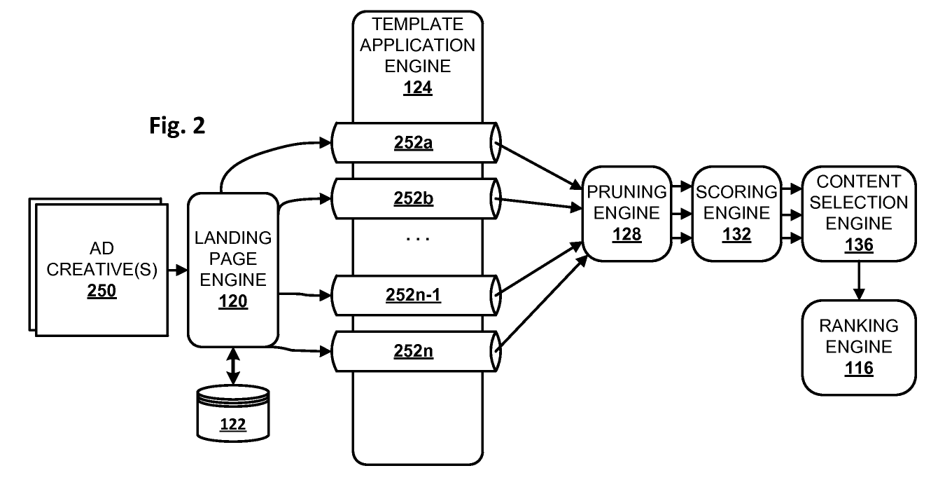

FIG. 2 depicts an example of how ad creatives and documents associated with destinations linked to by the ad creatives (e.g., landing pages and other pages in the same domain) may be analyzed by various components described herein to selectively augment visible content of the ad creatives. One or more ad creatives 250 may be provided to a landing page engine 120. Landing page engine 120 may identify, e.g., from index 122, one or more documents associated with a destination linked to by the ad creative(s) 250. For example, suppose an ad creative links to the URL “http://www.xyz.com/product_A.” Landing page engine 120 may at the very least retrieve the document or documents (e.g., if frames are used) associated with that URL, and may additionally retrieve other documents associated with the “www.xyz.com” domain. At noted above, landing page engine 120 may in some implementations perform various preprocessing of the documents it retrieves, such as pruning and/or annotation, before outputting one or more portions of one or more documents associated with destination(s) linked to by ad creative(s) 250.

Template application engine 124 may receive, as input, the one or more portions of one or more documents associated with a destination linked to by ad creative 250. Template application engine 124 may then selectively apply one or more of a plurality of templates 252a-n to these portions in order to identify one or more content candidates for possible augmentation of visible content of ad creative 250. These identified content candidates may then be output to downstream components.

Which of these templates 252 are applied by template application engine 124 may depend on a variety of factors. In some implementations, the template(s) selected may depend on a landing page “type,” one or more signals associated with an ad creative, and so forth. In some implementations, a template may include a relationship observed between content of one or more ad creatives and content of one or more corresponding landing pages. For example, to build a template, it may be observed that a large number of ad creatives with content A link to landing pages that include content B or syntactic variations thereof. Based on these multiple occurrences, a relationship R may be defined between contents A and B and incorporated into a template. In addition, a pattern that matches both contents A and B may be incorporated into the template.

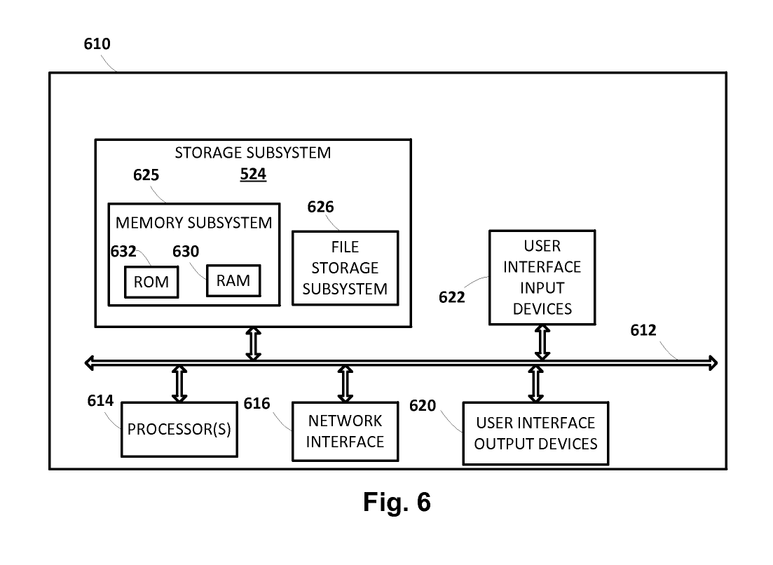

As noted above, templates (generically referenced by 252) may come in a variety of forms. For instance, one or more templates, such as first template 252a, may be an “instance” template. An “instance” template may be “learned” using a training corpus of ad creatives and documents associated with destinations linked to by the ad creatives. Ad creatives and corresponding documents may be examined, e.g., by parsing content of the documents into sentences and then generalizing the sentences into patterns (e.g., a regular expression). Instances of each of these patterns found in the corpus may then be counted to derive a measure of popularity. The pattern instance and associated measure of popularity together may comprise an instance template. Learning of instance templates will be described in more detail below regarding FIG. 6.

One or more other templates 252, such as second template 252b, may be a so-called “regular expression” template. A regular expression template may perform one or more regular expression matches over content of one or more documents associated with a destination linked to by ad creative 250. If content of a landing page matches a regular expression, that content (and/or a variant thereof) may be output by template application engine 124 as one of a plurality of content candidates.

One or more other templates, such as template 252n-1, may be so-called “parsing” templates. A parsing template may cause a parse tree (or graph) to be built based on portions of document content output by landing page engine 120. Various linguistic and/or parse tree-based rules may then be applied to determine whether content satisfies one or more criterion to be considered as a content candidate. For example, a criterion could be that a contiguous path within the parse tree contain particular tokens in order for the content represented by that path to be exported as a content candidate. Another criterion may be that a parse tree built with content of the document be sufficiently close to a parse tree associated with the template.

Yet other templates, such as template 252n may be so-called “rewriter” templates. A rewriter template may include one or more rewrite rules that, when applied to text (e.g., a string, an n-gram, a phrase, etc.), generate one or more variants of the original text. In some implementations, a rewriter template may be run against content of one or more documents associated with a destination linked to by ad creative 250. Additionally or alternatively, a rewriter template may be run against one or more content candidates identified by other templates 252. In either case, the output of rewriter template may include one or more additional content candidates to be considered by downstream components for augmentation of visible content of the ad creative.

Rewriter templates may employ various types of rewrite rules. In some implementations, one or more tokens of a string that have been identified (e.g., annotated) as adjectives may be deleted. In some implementations, one or more prepositional phrases may be removed, e.g., to rewrite “Buy product from Store 1” to “Buy product” (deleting “from Store 1”). In some implementations, delimiters such as stop words, conjunctions, possessives, and/or articles may be removed from a string to generate a variant. In some implementations, tokens may be replaced with synonyms. For example, a string “Buy great cars here” may be rewritten as “Buy excellent cars here.” One or more synonyms for one or more tokens may be identified and/or annotated by various components, such as landing page engine 120. In some implementations, multiple rewrite variants may be produced based on the presence of a conjunction. For example, a string “adopt puppies and kittens” may be rewritten as two separate rewrite variants, “adopt puppies” and “adopt kittens.” In some implementations, “chunking” may be employed, in which chucks of two or more tokens (e.g., a noun and a verb) are identified from a string, and provided in isolation as a separate content candidate.

In some implementations, one or more templates may be configured to identify content candidates based on sources other than documents associated with a destination linked to by an ad creative. For example, in some implementations, a semantic index of entities (not depicted in the Figures) may exist that tracks entities such as people, places, things, and relationships between those entities. Some templates may detect such an entity in an ad creative and, based on information contained in this semantic index of entities and relationships, may augment the ad creative. For instance, if a particular entity is detected and it is learned from the semantic index that the entity has been in business for YY years, then a content candidate “In business for YY years” may be automatically generated, regardless of whether such text appears in a landing page linked to by the ad creative.

Pruning engine 128 may be configured to prune one or more content candidates output by template application engine 124 in various ways. For example, pruning engine 128 may eliminate one or more content candidates based on one or more measures of redundancy detected between the one or more content candidates. If one content candidate is the phrase “MADE IN THE USA” and another is “MADE IN THE UNITED STATES,” pruning engine 128 may determine that these phrases are highly redundant, and may eliminate or otherwise disregard one or the other. As another example, pruning engine 128 may eliminate or otherwise disregard at least one content candidate based on a measure of redundancy detected between the content candidate and visible content of the ad creative. It would make little sense to add the phrase “MADE IN THE UNITED STATES” to an ad creative that already states, “MADE IN THE USA.”

In some implementations, pruning engine 128 may employ heuristics to eliminate content candidates. For instance, pruning engine 128 may examine content, e.g., from one or more documents that lead to identification of a content candidate, for nearby blacklisted terms, such as negating terms (e.g., “not,” “no,” “never,” etc.), subordinating conjunctions (e.g., “unless,” “if,” etc.), and/or wh-modifiers (e.g., “who,” “what,” “where,” etc.). Presence of such terms may cause pruning engine 128 to discard or otherwise disregard such content candidates. This avoids scenarios such as where a phrase such as “MADE IN THE USA” is extracted from a landing page, when the landing page actually says “NOT MADE IN THE USA.” Such blacklisted terms may be searched for in various locations, such as within a predetermined character or structured path distance (e.g., within x HTML or XML tags) of part of the document that led to identification of the content candidate, or even rendered within a certain number of pixels of that portion.

In some implementations, pruning engine 128 may employ more sophisticated techniques to eliminate content candidates. For instance, in some implementations, pruning engine 128 may build a parse tree based on the content of a document associated with a destination linked to by an ad creative. Pruning engine 128 may then inspect one or more nodes (e.g., ancestors of a portion) of the parse tree that led to identification of a content candidate to determine whether the content candidate satisfies a criterion. For example, in some implementations, the criterion comprises absence of blacklisted terms (e.g., negations. subordinating conjunctions, wh-modifiers) in the one or more nodes in the parse tree. In some implementations, if a content candidate is not represented by a contiguous path of a parse tree, that content candidate may be checked against the ad creative to ensure it is compatible with a context of the ad creative.

In some implementations, scoring engine 132 may additionally or alternatively be provided to calculate scores associated with each of the content candidates (e.g., that remain after pruning), and/or to rank the content candidates based on these scores. These scores may be indicative of a suitability of content candidates for use in augmenting visible content of a particular ad creative, or of ad creatives in general. Scoring engine 132 may calculate content candidate scores based on a variety of signals. In some implementations, the signals may emanate or otherwise be associated with an ad creative. In some implementations, the signals may come from elsewhere, such as from client device 102 (e.g., contextual clues such as location, calendar, user activity, etc.).

In some implementations, scoring engine 132 may score and/or rank a plurality of content candidates based on semantic similarity (alternatively referred to as “embedding similarity”) between the candidates and visible content of the ad creative. A corpus of ad creatives and documents associated with destinations linked to by the ad creatives may be examined to determine frequency of collocation between particular content of an ad creative and corresponding content of a landing page. For example, suppose an ad creative with the visible text “FREE DELIVERY” has been observed in the past frequently linking to landing pages with text such as “We deliver to your home or business for free.” Suppose further that the latter phrase or a slight variation thereof is identified as a content candidate based on a document associated with a destination linked to by an ad creative, and that the ad creative is silent about free delivery. Scoring engine 132 may assign that particular content candidate a relatively high score.

In some implementations, scoring engine 132 may score and/or rank a plurality of content candidates based on templates used to identify them. For example, as noted above, a pattern instance and associated measure of popularity together may comprise an instance template. The associated measure of popularity may be taken into account when determining a score and/or ranking a content candidate. For instance, a first content candidate identified using a first template with a relatively high measure of popularity may be scored higher than a second content candidate identified using a second template with a relatively low measure of popularity.

In some implementations in which one or more rewriter templates are applied to generate one or more variants as content candidates, scoring engine 132 and/or pruning engine 128 may consider one or more measures of the applied rewrite rules to score a content candidate. For example, a “rewrite cost” may be a measure of how different a rewrite is from the original content. In some instances, the more rewrite rules that are applied, the higher the rewrite cost. In some implementations, a low rewrite cost may indicate little different between an original content and a rewrite variant thereof, and may result in the variant content candidate being ranked higher. Another metric is “edit distance,” in which one or more measures (e.g., Damerau-Levenshtein) between the rewrite variant and the original content are considered. Text length may be another metric that is considered. Longer or shorter rewrites may be scored higher or lower, depending on the circumstances. Parts of speech of a rewrite variant may also be considered. For instance, a variant content candidate may be scored based on counts of verbs, adjectives, nouns, and so forth.

In some implementations, scoring engine 132 may score and/or rank a plurality of content candidates based on occurrence of those candidates across multiple documents, e.g., across multiple web pages in a web site (i.e. a domain). For instance, occurrence of a particular content candidate in both a landing page and in other pages under the same domain may be indicative of the content candidate being suitable for ad creative augmentation. A slogan provided on all web pages of a company's domain, for example, may be suitable for inclusion in an ad creative. In some implementations, content candidates may be scored, e.g., by scoring engine 132, based on their relative ubiquity across a domain. A candidate that appears (literally or in the form of a variation) across 80% of a domain's pages may receive a higher score than another candidate that appears across 10% of the domain's pages. In some implementations, if the ubiquity of a content candidate satisfies a threshold (e.g., it is present in over 90% of a domain's web pages), that content candidate may be automatically identified/generated any time an entity associated with that domain is the subject of an ad creative.

In some implementations, pruning engine 128 and/or scoring engine 132 may consider one or more of a context of the ad creative and a context of content of a landing page that caused identification of a content candidate in determining whether to prune and/or scoring a content candidate. For instance, content candidates that are inaccurate (e.g., out-of-date landing page states “WHOLE STORE 50% OFF”) or that otherwise would be out of context if included in the ad creative may be pruned and/or given a relatively low score. Suppose a template is configured to identify instances of “free of charge” or variants thereof (“no charge,” complementary,” etc.) in landing pages. However, suppose that a particular landing page for a hotel includes the text “Wi-Fi internet access is free of charge.” It may not be desirable to promote the phrase “free of charge” to an ad creative for the hotel because taken out of context, the phrase might be taken to mean that the entire hotel room is free, when really it is only Wi-Fi internet access that is supposed to be free.

In some implementations, pruning engine 128 and/or scoring engine 132 may consider one or more of a category/taxonomy of the ad creative and/or a category/taxonomy of a content creative in determining whether to prune and/or scoring the content candidate. For example, ad creatives associated with the category “electronics” may have been observed historically to have CTRs based on presence of particular types of visible content, such as “knowledgeable staff,” “XYZ certified,” and so forth. A content candidate that matches a pattern extrapolated from such content may be ranked higher than other content candidates. As another example, suppose that, historically, ad creatives of the category “home services” that include visible content such as “prompt service” or “guaranteed arrival within XX minutes of scheduled time” experience relatively high CTRs. Content candidates with similar structure (e.g., matching extrapolated patterns) may be ranked relatively high. As another example, ad creatives associated with “Financials” may have experienced higher CTRs when they include content such as “trustworthy,” “dependable,” and so forth. Content candidates that are somehow related to these phrases (e.g., synonymous, semantically related, etc.) may be scored relatively high. As another example, ad creatives associated with “diapers” may have experienced higher CTRs when they include content such as “discount,” “dry,” and so forth.

In some implementations, pruning engine 128 and/or scoring engine 132 may determine whether an age of a content candidate satisfies an age criterion. For example, the age criterion may be an absolute maximum age (e.g., five days, two weeks, two months, a year, etc.). A content candidate identified based on a landing page that does not satisfy the age criterion may be considered “stale,” and may be pruned and/or assigned a low score. As another example, the age criterion may be a maximum age relative to an age of the ad creative. A content candidate that is closer in age to an ad creative than a predetermined amount may be considered “fresh,” and may receive a relatively high score. In some implementations, a content candidate may be scored based on its temporal sensitivity. For example, a timeless content candidate such as “always serving the best cakes in town” may be considered less temporally-sensitive, and hence may be scored higher, than another content candidate which reads “breakfast special ends soon.” In some implementations, temporally-sensitive content candidates may be discarded (e.g., by pruning engine 128) altogether, to avoid the risk of contaminating visible content of an ad creative with potentially untimely information.

In some implementations, pruning engine 128 and/or scoring engine 132 may consider one or more aspects of a parse tree built by landing page engine 120 when pruning and/or ranking content candidates. In various implementations, one or more aspects of the parse tree that are considered may include negation language, path distances, restrictive clauses, presence of prepositional modifiers, and/or one or more dependency paths. For example, presence of negation language may lower a score associated with a content candidate. As another example, path distance, e.g., between nodes of a parse tree representing an ad creative and another parse tree representing a content candidate, may also be considered. As another example, constituencies and/or other aspects of dependency paths may be analyzed to determine, for instance, when a particular phrase may be misleading.

While FIG. 2 depicts pruning engine 128 and scoring engine 132 as separate components, this is not meant to be limiting. In some implementations, one or the other may be omitted, or the two components may be implemented together. For example, in some implementations, rather than “pruning” content candidates, content candidates may simply be scored. Content candidates with scores below a particular threshold, or the bottom N content candidates, may be discarded and/or otherwise disregarded. Remaining content candidates may be ranked, and then the top M candidates may be selected, e.g., by content selection engine 136, to augment visible content of an ad creative.

Content selection engine 136 may be configured to select one or more content candidates to augment visible content of ad creative 250 based on the scores. For example, in FIG. 2, content selection engine 136 selects and provides content candidate(s) to ranking engine 116, which may augment one or more ad creatives 250 and return those as sponsored search results to a user. In other implementations, content selection engine 136 may pass augmented ad creatives back to indexing engine 112, which may store them in index 114 for future use.

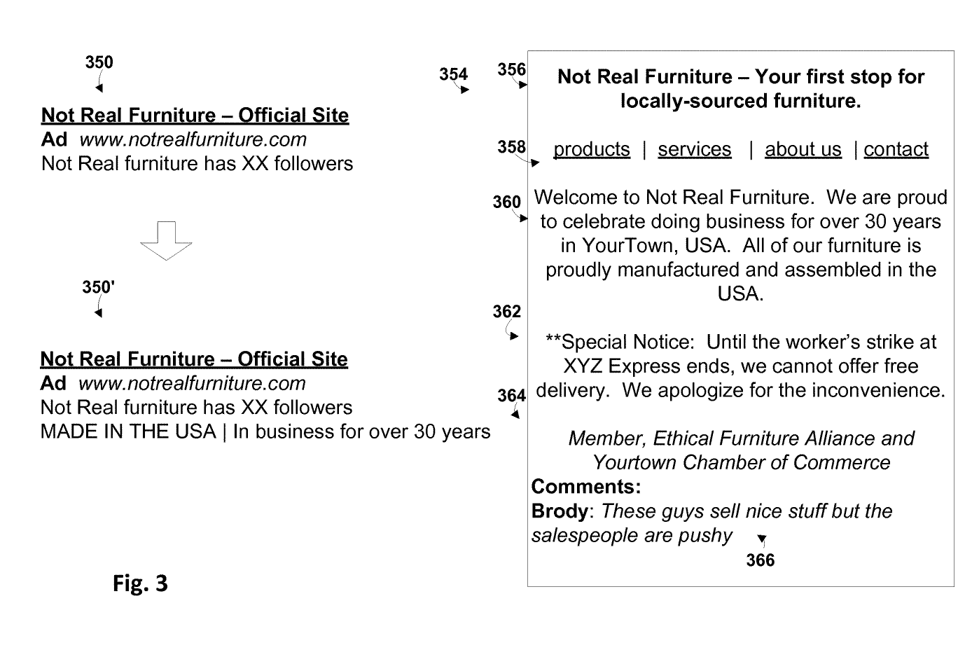

FIG. 3 depicts an example of how visible content of an ad creative may be augmented based on content of a landing page linked-to by the ad creative, in accordance with various implementations. An example unaugmented ad creative 350 appears at top left, a landing page 354 linked to by ad creative 350 appears on the right, and an augmented version of ad creative 350′ appears at bottom left. Landing page 354 includes various portions which may or may not be suitable locations from which to identify content candidates for possible augmentation of ad creative 350. For example, landing page 354 includes a title portion 356, a site links portion 358, a “centerpiece” portion 360 that includes a special announcement 362 at bottom, a boilerplate portion 364, and a comments portion 366.

As noted above, unaugmented ad creative 350 may be presented on client device 102 in a variety of applications, such as in browser 106, application store client 108, and/or shopping client 110. In one or more of these applications, ad creative 350 may be presented as a “sponsored” search result, e.g., above or to the side of other (e.g., “web”) search results. As presented, visible content of unaugmented ad creative 350 may be insufficiently compelling, which may result in a suboptimal CTR. However, using techniques described herein, unaugmented ad creative 350 may be augmented (as indicated by the arrow) based on content of landing page 354 to augmented ad creative 350′. Augmented ad creative 350′ may be more compelling to users, which may, for instance, raise its CTR.

In this example, landing page 354, which may have been retrieved by landing page engine 120 in response to various events (e.g., ranking engine 116 selecting unaugmented ad creative 350 for presentation as a sponsored search result), may be examined to identify potential content candidates with which to augment visible content of ad creative 350. One or more portions of landing page 354, such as site links 358 or comments 366, may be pruned by landing page engine 120. One or more templates may then be applied, e.g., by template application engine 124, to match or locate various text in remaining portions of landing page 354. For example, one template configured to match instances of “MADE IN THE USA” or variants thereof (e.g., <{POSITIVE ADJECTIVE} {VERB} “IN THE ”{UNITED STATES|US|USA|U.S.A.}>) may match the text “ . . . proudly manufactured and assembled in the USA.” Another template configured to match instances of “IN BUSINESS FOR OVER XX YEARS” or variants thereof (e.g., “ESTABLISHED IN XXXX,” “DOING BUSINESS SINCE XXXX,” etc.) may match the text “ . . . doing business for over 30 years . . . ” Yet another template configured to match instances of “FREE SHIPPING” or variants thereof (e.g., “NO CHARGE FOR SHIPPING,” “DELIVERY FREE OF CHARGE,” etc.) may match the text “ . . . free delivery.”

The first two content candidates may be assigned relatively high scores based on various signals. It may be that the template that matched “manufactured and assembled in the USA” has a high popularity measure because most ad creatives touting “MADE IN THE USA” experience relatively high CTR s. Moreover, there is nothing in the context of unaugmented ad creative 350 or the landing page 354 that contradicts (e.g., contextually) inclusion of this phrase in unaugmented ad creative 350. Thus, the content candidate identified using this template may receive a relatively high score. The same may go for the content candidate “ . . . doing business for over 30 years”. However, the third content candidate (“ . . . free delivery”) may receive a lower score. While content candidates identified using that respective template may normally be scored highly (e.g., consumers may place considerable value in free shipping), in this instance, the “ . . . free delivery” content candidate is only beneficial out of context. In the context of landing page 354, the negating language “we cannot offer . . . ” modifies the content candidate to give it an entirely different meaning. It would not be desirable to augment unaugmented ad creative 350 with “free shipping” considering that's exactly the opposite of what landing page 354 promises.

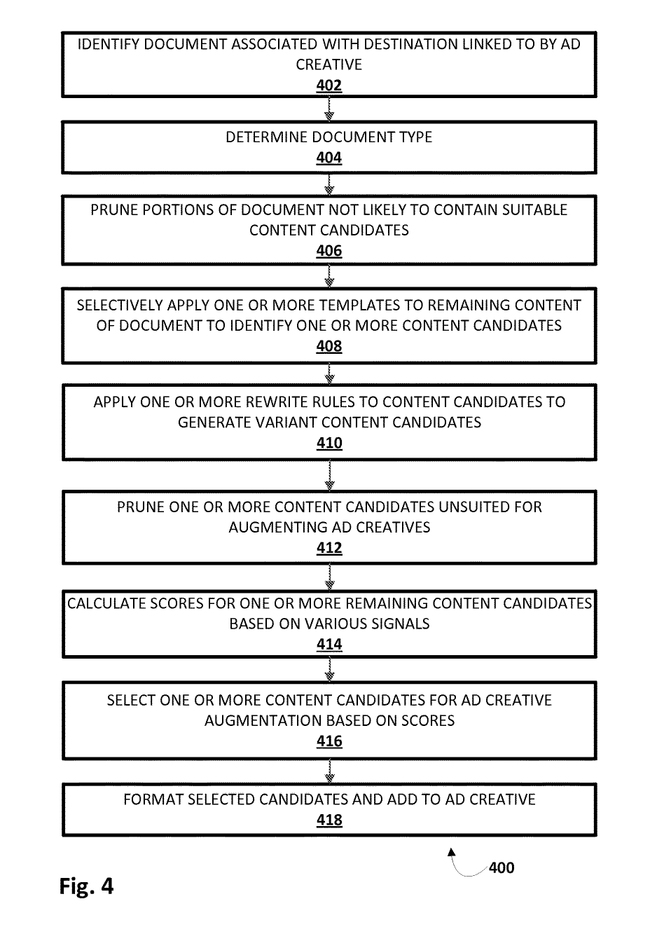

Referring now to FIG. 4, an example method 400 of promoting, to visible content of an ad creative, content from one or more documents associated with a destination linked to by the ad creative is described. For convenience, the operations of the flow chart are described with reference to a system that performs the operations. This system may include various components of various computer systems, including various engines described herein. Moreover, while operations of method 400 are shown in a particular order, this is not meant to be limiting. One or more operations may be reordered, omitted or added.

At block 402, the system may identify one or more documents associated with a destination linked to by an ad creative under consideration for augmentation. In some instances, each ad creative of a corpus of ad creatives may be individually considered for augmentation, e.g., to make it more compelling when used in the future, and documents associated with a destination linked to by those ad creatives may be retrieved. Alternatively, an ad creative that is to be returned as a “sponsored” search query result may be considered for augmentation in real time, and corresponding documents may likewise be retrieved in real time.

However the one or more documents are identified at block 402, at block 404 (which it should be emphasized is optional), the system may determine a type of the one or more documents. For instance, in some implementations, a document directly linked to by an ad creative may be deemed a “landing page,” whereas other document in the same domain may be deemed “associated” pages. In some implementations, documents may be assigned other types commensurate with various document attributes, such as media type (e.g., web page, photo, video, spreadsheet, presentation), source (e.g., domain), and so forth.

At block 406, the system may prune one or more portions of the document unlikely to contain content candidates suitable for ad creative augmentation. For example, portions containing user comments, advertisements for unrelated products, and so forth, may be discarded or otherwise annotated as “irrelevant” to downstream components.

At block 408, the system may selectively apply one or more templates to remaining content of the document to identify one or more content candidates. As noted above, one or more templates of multiple templates may be selected based on various signals and applied. One signal that may be used to select a template for application is the document type determined at block 404. For example, if the document type is “inappropriate,” “NSFW,” “unavailable,” “stale” (e.g., because the document is older than a predetermined age and/or is too much older than an ad creative under consideration), and/or “inaccurate,” no template may be applied. Another signal that may be used to select a template for application is one or more attributes of the template itself (e.g., a measure of popularity). Yet another signal that may be used to select a template for application is one or more signals associated with the ad creative. For example, templates that would likely return content candidates that are redundant to existing visible content of an ad creative may not be applied.

At block 410, the system may apply one or more rewrite rules to content candidates identified at block 408 to identify variants thereof. These variants may be considered as additional content candidates. In some implementations, the rewrite rules may be part of a template that is applied at block 408.

At block 412, the system may prune one or more content candidates based on various signals and using various techniques (e.g., heuristics, linguistic rules, etc.). At block 414, the system may score one or more remaining content candidates based on various signals. These signals, some of which are described previously, may include but are not limited to signals associated with the ad creative (e.g., its length, its content, its age) and signals associated with one or more documents associated with a destination linked to by the ad creative (e.g., its length, context, age). Additionally or alternatively, these signals may include signals indicative of informativeness of a content candidate and/or the document from which it was identified, a score associated with a template that was applied to identify the content candidate, and so forth. As noted previously, in some implementations, block 412 (content candidate pruning) may be skipped, and content candidates may simply be scored.

At block 416, the system may select one or more content candidates for use in augmenting the ad creative based on the one or more scores determined at block 412. As noted above, in some implementations, the top N scoring content candidates may be selected. In various implementations, the system may select N based on various signals pertaining to the ad creative such as its length. There may a point past which augmenting visible content of an ad creative with additional content may yield diminishing returns. Thus, N may be smaller for a verbose ad creative than for a sparse ad creative.

At block 418, the system may format the one or more content candidates selected at block 416 in various ways for augmenting the ad creative. For example, the system may select one or more formatting attributes for the content candidate based on one or more formatting attributes of the ad creative, so that the content candidate may seamlessly fit in.

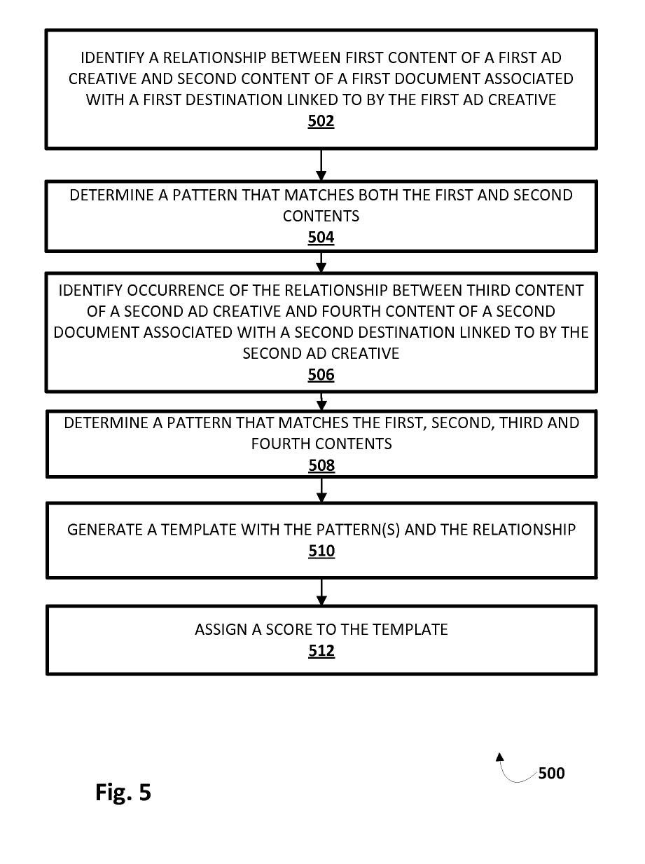

Referring now to FIG. 5, an example method 500 of generating one or more templates based on a corpus of ad creatives and documents associated with destinations the ad creative is described. For convenience, the operations of the flow chart are described with reference to a system that performs the operations. This system may include various components of various computer systems, including various engines described herein. Moreover, while operations of method 500 are shown in a particular order, this is not meant to be limiting. One or more operations may be reordered, omitted or added.

At block 502, the system may identify a relationship between first content of a first ad creative and second content of a first document associated with a first destination linked to by the first ad creative. As noted above, such a relationship may take various forms, such as equivalency (e.g., the same content in the ad creative and document), syntactic (e.g., “YourTown's oldest law firm” and “The oldest law firm in YourTown”), semantic, and so forth.

For example, in a corpus of ad creatives and linked to documents, the system may semantically identify, from multiple ad creatives, instances of a known entity name (e.g., from a semantic index) and, in a corresponding landing page, a statement of the known entity's age (e.g., “Doing business for over 20 years”), thus identifying a semantic relationship, <entity, entity age>. The system may generalize a semantic relationship that applies to any entity of any age that can be determined from the semantic index. When subsequent application that template identifies an entity in an ad creative, and an age of that entity can be determined from the semantic index, a content candidate such as “doing business for over YY years” may be automatically generated. In some implementations, such a content candidate may be generated only where the age satisfies a threshold. In some implementations, such a threshold may be determined while training the template on a corpus of ad creatives and corresponding linked to documents. If entities that tout their ages are primarily over a certain number of years old, then that may be used to determine the threshold.

As another example, in some implementations, the system may apply one or more rewrite rules to generate one or more variants of content of the ad creative, and then determine that one or more of those variants is present in a linked to landing page. The reverse may also be true: content of a landing page may be rewritten according to one or more rewrite rules, and it may be determined that one of the variants matches visible content of the ad creative.

At block 504, the system may determine a pattern that matches both the first content of the first ad creative and the second content of the first document associated with the first destination linked to by the first ad creative. Suppose an ad creative states “Serving YourTown since 1976,” and the corresponding landing page states “Helping YourTown since 1976.” These two statements may be generalized to <{gerund verb} {location} since {year}>, or something to that affect.

At block 506, the system may identify occurrence of the same relationship as was identified at block 502 between third content of a second ad creative and fourth content of a second document associated with a second destination linked to by the second ad creative. Identifying another occurrence of such a relationship may support a conclusion that users desire or expect the particular relationship to be present between ad creatives and linked to landing pages. This conclusion may be solidified and/or corroborated at block 508, when the system determines a pattern that matches the first, second, third and fourth patterns.

At block 510, the system may generate a template that incorporates the relationship(s) and/or pattern(s) identified at blocks 502-508. As alluded to above with regard to block 506 and 508, such a template may be applied to one or more documents associated with one or more destinations linked to by one or more ad creatives. If matching content is found in the document(s) and is not present in the corresponding ad creative, the system may utilize the relationship in the template to identify and/or extract from the document(s) content with to be considered as a content candidate for augmentation of visible content of the ad creative. For example, of the relationship in the template is simple equivalency, then the system may extract the content from the document(s). As another example, suppose a template incorporates a relationship in which a rewrite variant of content of a landing page matched visible content of a corresponding ad creative. Such a template (and its one or more rewrite rules) may be applied to a subsequent landing page to generate a similar variant of content of the landing page. This variant may then be considered as a content candidate for augmenting visible content of the ad creative.

Returning to FIG. 5, at block 512, one or more scores may be assigned to one or more templates based on various signals. In some implementations, a score may affect a likelihood that a template will be selected from a plurality of templates. As noted above, the more a relationship and/or pattern is observed between content of multiple ad creatives and linked to documents, the more a score associated with the template incorporating that relationship and/or pattern may be affected (e.g., increased). In some implementations, other metrics associated with a training corpus of ad creatives and/or linked to documents may be considered. For example, if a particular ad creative has an extremely high CTR to a particular document, and/or if users tend to remain at the document (or navigate mostly to closely related documents in the same domain), any relationship and/or pattern identified between the ad creative and linked to document(s) may receive a score indicative of strong relationship. In some implementations, a template's score may be determined based at least in part on a term frequency-inverse document frequency of one or more n-grams of one or more documents associated with a destination linked to by an ad creative.

FIG. 6 is a block diagram of an example computer system 610. Computer system 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computer system 610. Network interface subsystem 616 provides an interface to outside networks and is coupled to corresponding interface devices in other computer systems.

User interface input devices 622 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 610 to the user or to another machine or computer system.

Storage subsystem 624 stores programming and data constructs that provide the functionality of some or all of the modules described herein. For example, the storage subsystem 624 may include the logic to perform selected aspects of methods 400 and/or 500, and/or to implement one or more of indexing engine 112, ranking engine 116, landing page engine 120, template application engine 124, pruning engine 128, scoring engine 132, and/or content selection engine 136.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computer system 610 communicate with each other as intended. Although bus subsystem 612 is shown schematically as a single bus, alternative implementations of the bus subsystem may use multiple busses.

Computer system 610 can be of varying types including a workstation, server, computing cluster, blade server, server farm, or any other data processing system or computing device. Due to the ever-changing nature of computers and networks, the description of computer system 610 depicted in FIG. 6 is intended only as a specific example for purposes of illustrating some implementations. Many other configurations of computer system 610 are possible having more or fewer components than the computer system depicted in FIG. 6.

In situations in which the systems described herein collect personal information about users, or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A computer-implemented method, comprising:
identifying a document associated with a destination linked to by an ad creative;
applying one or more templates to content of the document to identify at least one content candidate with which to augment visible content of the ad creative;
determining that the at least one content candidate satisfies a criterion; and
augmenting visible content of the ad creative based on the at least one content candidate.

2. The computer-implemented method of claim 1, wherein the determining comprises:
calculating scores for a plurality of content candidates; and
selecting, from the plurality of content candidates, a content candidate for the augmenting based on the scores.

3. The computer-implemented method of claim 2, wherein calculating a score for a given content candidate comprises calculating the score based on a comparison of a first context in which the given content candidate is associated with the document and a second context associated with the ad creative.

4. The computer-implemented method of claim 2, further comprising eliminating one or more content candidates from the plurality of content candidates based on one or more measures of redundancy detected between the one or more content candidates.

5. The computer-implemented method of claim 2, further comprising eliminating at least one content candidate from the plurality of content candidates based on a measure of redundancy detected between the at least one content candidate and the visible content of the ad creative.

6. The computer-implemented method of claim 2, further comprising ranking the plurality of content candidates based on semantic similarity with visible content of the ad creative.

7. The computer-implemented method of claim 2, further comprising ranking the plurality of content candidates based on templates used to identify them.

8. The computer-implemented method of claim 2, further comprising ranking the plurality of content candidates based on a category assigned to the ad creative.

9. The computer-implemented method of claim 1, wherein the criterion comprises a first context associated with the document being compatible with a second context associated with the ad creative.

10. The computer-implemented method of claim 1, further comprising:
building a parse tree based on the content of the document; and
ranking a plurality of content candidates based on one or more aspects of the parse tree.

11. The computer-implemented method of claim 10, wherein the one or more aspects of the parse tree include absence or presence of negation language, one or more path distances, or one or more restrictive clauses.

12. The computer-implemented method of claim 1, wherein determining that the at least one content candidate satisfies the criterion includes determining that an age of the at least one content candidate satisfies an age criterion.

13. (canceled)

14. (canceled)

15. The computer-implemented method of claim 1, further comprising:
identifying one or more rewrite rules for the at least one content candidate; and
generating one or more rewrites of the at least one content candidate based on the one or more rewrite rules.

16. The computer-implemented method of claim 15, further comprising selecting, from the at least one content candidate and the one or more rewrites, content with which to augment the visible content of the ad creative.

17. The computer-implemented method of claim 1, further comprising selecting the one or more templates from a plurality of templates based on one or more signals associated with the ad creative.

18. The computer-implemented method of claim 1, further comprising selecting the one or more templates from a plurality of templates based on one or more signals associated with the document or the destination.

19. A computer-implemented method, comprising:
identifying, by a computing system, a relationship between first content of a first ad creative and second content of a first document associated with a first destination linked to by the first ad creative; and
generating, by the computing system, a template configured to identify, based on the relationship and a second document associated with a second destination linked to by a second ad creative, candidate content with which to augment visible content of the second ad creative.

20. The computer-implemented method of claim 19, further comprising:
determining, by the computing system, a pattern that matches both the first and second contents; and
incorporating, by the computing system, the pattern into the template, wherein the template is further configured to match the pattern to third content of the second document.

21. The computer-implemented method of claim 20, wherein the template is further configured to identify the candidate content based on the third content.

22. (canceled)

23. (canceled)

24. (canceled)

25. (canceled)

26. A system including memory and one or more processors operable to execute instructions stored in the memory, comprising instructions to:
identify a document associated with a destination linked to by an ad creative;
apply one or more templates to content of the document to identify a plurality of content candidates with which to augment visible content of the ad creative;
determining scores associated with the plurality of content candidates based at least in part on the context of the ad creative or a context associated with content of the document; and
selecting one or more content candidates for augmentation of visible content of the ad creative based on the scores.
